(19) United States
(12) Patent Application Publication
(10) Pub. No.: US 2024/0231849 A1
(43) Pub. Date: Jul. 11, 2024

(54) WORKFLOW AUTHORIZATION MANAGEMENT

(71) Applicant: VMware, Inc., Palo Alto, CA (US)

(72) Inventor: Emil Popov, Sofia (BG)

(21) Appl. No.: 18/095,774

(22) Filed: Jan. 11, 2023

(51) Int. Cl. G06F 9/445; G06F 9/451

(52) U.S. Cl. CPC G06F 9/44526; G06F 9/451

(57) ABSTRACT

Systems and methods are described for managing workflow authorizations of a workflow automation plug-in. In an example, an administrator user can add a workflow and assign a user group to a server cluster in a workflow automation plug-in running in a server management application where the cluster is managed. The plug-in can create a contextual element that includes data identifying the workflow, object type that the workflow acts on, and mappings to data of both the workflow automation application and the server management application, such as the cluster, workflow, and objects of the object type. The plug-in can also map the user group to the cluster. When an end user access the plug-in for the cluster, the plug-in can use the contextual element to make the workflows available to the user in an interface.

### BACKGROUND

Plug-ins are software components that add a specific feature to an existing computer software application. Plug-ins can allow a developer to insert certain features of one software application into another. This can be particularly useful in computing systems where different applications operate on some of the same data or objects. A plug-in allows a user to utilize features of both applications from the same interface without switching back and forth.

For example, server management applications provide a centralized platform for controlling cloud computing virtualization environments, such as virtual server clusters. Workflow automation applications provide a platform for simplifying and automating complex data center infrastructure tasks. These two types of applications, when used by an organization like an enterprise organization, often operate on the same computing environments. A plug-in can allow a user to access the features of both applications in a single interface. As an example, VMWARE VCENTER application is a server management application that includes a plug-in, called VCOIN, for VMWARE VREALIZE ORCHESTRATOR, which is a workflow automation application. VCOIN allows a user to manage automated workflows for clusters from within the VREALIZE ORCHESTRATOR interface.

For a plug-in to function properly, the plug-in must be able to verify users and determine what permissions they have for executing workflows on a cluster. For example, the plug-in must be able to determine whether a user is authorized to run workflows on a particular cluster. Also, when adding a workflow to a cluster managed in the server management application, the workflow needs to be made available to users on the side of the workflow automation application.

As a result, a need exists for providing workflow authorizations and restrictions over workflows for users logged into a workflow automation plugin in a server management application.

### SUMMARY

Examples described herein include systems and methods for workflow authorization management. In an example, a server management application can include a plug-in for a workflow automation application. The server management application can allow users to manage certain aspects of servers in a computing system. The workflow automation application can allow users to manage automated workflows at the servers. The plug-in can allow users to manage the automated workflows from within the server management application.

The plug-in can allow administrator (“admin”) users to add workflows to a server cluster and to assign users and user groups to the cluster. Adding a workflow to a cluster can allow end users who are assigned to the cluster to execute the workflow. Adding a user group to a cluster can allow all users assigned to the group to execute the workflows added to the cluster.

In an example, the plug-in can include an interface for adding automated workflows to a server. An admin user can add an automated workflow by selecting or defining a workflow and an object type that the workflow acts on. Some examples of workflows include adding, migrating, or removing virtual machines (“VMs”), creating snapshots of VMs in a resource pool, and so on. Some examples of object types can include clusters, resource pools, and host machines.

When an admin user adds an automated workflow to a cluster, the plug-in can create a contextual element. A contextual element can be a data table or array that includes data mapping to the workflow, data mapping to objects of the object type, and other necessary information for executing the workflow. As an example, the contextual element can include a workflow identifier (“ID”) that maps to a script or executable code for executing the workflow. The contextual element can also include a second ID that maps to an array with IDs of objects of the selected object type in the cluster. The contextual element can also map to a cluster data table with data related to the corresponding cluster. The contextual element can map to data managed at different locations. For example, the workflow script or code can be retained and managed by the workflow automation application, and the cluster and object data can be retained and managed by the server management application. The contextual elements therefore give the plug-in access to the data at both locations that it needs to execute the workflow.

The plug-in can also allow an admin user to assign user groups, or individual users, to the cluster. Assigning a user group to a cluster in the plug-in can give all end users in the group access to run the automated workflows added to the cluster. In one example, when the admin user assigns a user group, the plug-in can store the assignment in the cluster data table.

The contextual element can map to data managed at different locations. For example, the workflow script or code can be retained and managed by the workflow automation application, and the cluster and object data can be retained and managed by the server management application. The contextual elements therefore give the plug-in access to the data at both locations that it needs to execute the workflow. The mappings allow an admin to quickly manage workflow authorizations for server clusters. For example, to add or remove access to a cluster, an admin user can assign or unassign the corresponding user group using the plug-in. To add or remove authorization to run a workflow on a cluster, the admin user can add or remove the automated workflow using the plug-in, which creates or removes the mappings used to give access to the automated workflow.

When an end user accesses the plug-in from the server management application for a particular cluster, the plug-in can populate a list of available workflows using the mappings described above. For example, the plug-in can receive or retrieve IDs of user groups that the end user is assigned to. The plug-in can compare the user group IDs to the cluster data table to determine whether any of the user groups are assigned to the cluster. If so, the plug-in can retrieve the contextual elements identified in the cluster data table. The plug-in can populate a list of automated workflows based on information in the contextual elements.

When a user selects an automated workflow to run, the plug-in can use mappings in the contextual element to execute the workflow. For example, the plug-in can retrieve the script or executable code that the workflow's ID maps to. In an example, the workflow scripts or code can be retained by the workflow automation application. The plug-in can also retrieve a list or array of object IDs corresponding to the object type of the automated workflow. In an example, data pertaining to objects, such as VMs, running on the cluster can be retained by the server management application. The plug-in can execute the workflow script or code using the object IDs in any appropriate manner. For example, for each VM the plug-in can insert the corresponding ID into the script, such as into a placeholder, and then execute the script on the servers hosting the VMs. In another example, the VM can execute the script on the VMs themselves.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1A is a flowchart of an example method for managing authorizations of automated workflows.

FIG. 1B is a flowchart of an example method for implementing workflow automation authorizations.

FIG. 2 is a sequence diagram of an example method for managing authorizations of automated workflows.

FIG. 3 is another sequence diagram of an example method for implementing workflow automation authorizations.

FIG. 4 is an illustration of an example graphical user interface (“GUI”) for workflow authorization management.

FIG. 5 is an illustration of another example GUI for workflow authorization management.

FIG. 6 is an illustration of an example system for managing authorizations of automated workflows.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for managing workflow authorizations of a workflow automation plug-in. In an example, an administrator user can add a workflow and assign a user group to a server cluster in a workflow automation plug-in running in a server management application where the cluster is managed. The plug-in can create a contextual element that includes data identifying the workflow, object type that the workflow acts on, and mappings to data of both a workflow automation application and the server management application, such as the cluster, workflow, and objects of the object type. For example, data relating to cluster and objects can be managed by the server management application, and data relating to the workflow can be managed by the workflow automation application. The plug-in can also map the user group to the cluster. When an end user access the plug-in for the cluster, the plug-in can use the contextual element to make the workflows available to the user in an interface.

The example methods herein describe stages that can be performed by a workflow automation plug-in. The workflow automation plug-in can be a software component that adds features of a workflow automation application into another application. A workflow automation application can be a software application that simplifies and automates complex data center infrastructure tasks. One example of a workflow automation application is VMWARE VREALIZE ORCHESTRATOR. The workflow automation plug-in can allow users to access, configure, and schedule workflow executions from another application, such as server management software. As an example, VMWARE VREALIZE ORCHESTRATOR includes a plug-in called VCOIN that can be deployed in VMWARE VCENTER, which is a server management software that provides a centralized platform for controlling cloud computing virtualization environments, such as virtual server clusters. Using the VCOIN plugin, a user can access a cloud computing virtualization environment in VCENTER and perform automated workflow actions provided by VREALIZE ORCHESTRATOR through the VCOIN plug-in. VCOIN is just one example of a workflow automation plug-in. The examples described herein can be implemented in any computing environment that includes a workflow automation plug-in for a workflow automation application deployed in a server management application.

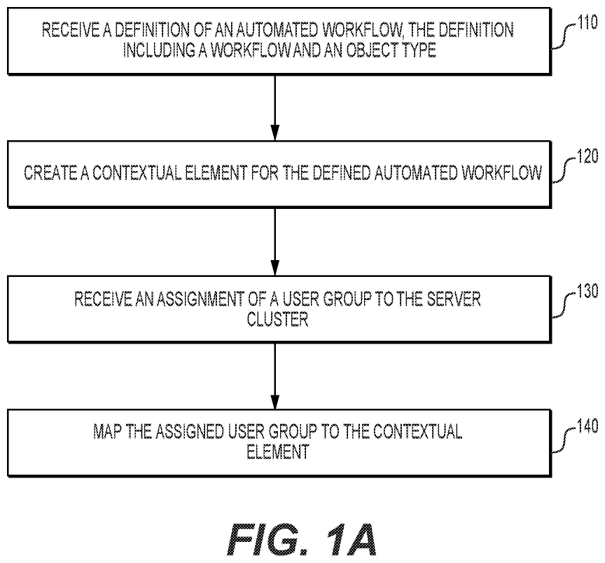

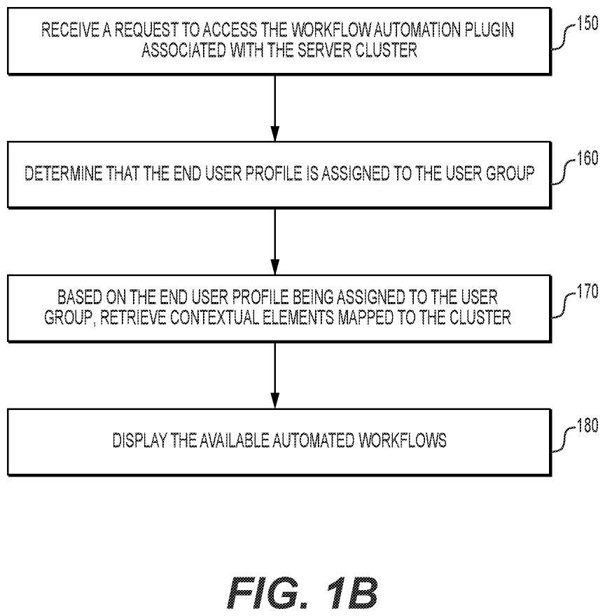

FIG. 1A is a flowchart of an example method for managing authorizations for automated workflows. At stage 110, a workflow automation plug-in can receive a definition of an automated workflow, the definition including a workflow and an object type. As explained previously, the workflow automation plug-in can be a software plug-in for a workflow automation application that runs within a server management application. The automated workflow definition can be received from user input through a GUI of the server management application (hereinafter referred to as the “server management GUI”). More specifically, the automated workflow definition can be received through a portion of the GUI corresponding to the workflow automation plug-in (hereinafter referred to as the “plug-in GUI”).

The workflow automation plug-in can allow users to manage workflows for servers or server clusters that are managed from within the software management application. The terms “server cluster” and “cluster” are used herein interchangeably and refer to a single server or a group of servers. For example, a user can navigate to a page in the server management GUI for a server cluster and select the workflow automation plug-in on the cluster's page. This selection can cause the software management application to open the plug-in GUI with automated workflow information specific to that cluster. In one example, the automated workflow information can be retrieved from the workflow automation application by the workflow automation plug-in. The plug-in GUI for a cluster can include workflow management page. Among other things, the workflow management page can allow certain users to add, edit, and delete automated workflows. In one example, the workflow automation plug-in can include a permissions system that manages the types of actions available to various user types. For example, admin users can perform any available action through the plug-in, and end users can be restricted to certain actions, such as only executing certain workflows.

When adding an automated workflow, an admin user can define the workflow and an object type that the workflow is to be performed on. For example, the workflow management page can include a selection mechanism, such as a selectable button, that, when selected, causes the workflow management page to display a new workflow window where the admin user can define a new automated workflow. The new workflow window can include options for selecting a workflow and an object type. Some examples of workflows include removing virtual machines from a resource scheduler group, creating snapshots of virtual machines, moving virtual machines to a resource pool, and moving virtual machines to another server. Some examples of object types include a server cluster, a resource pool, and a host.

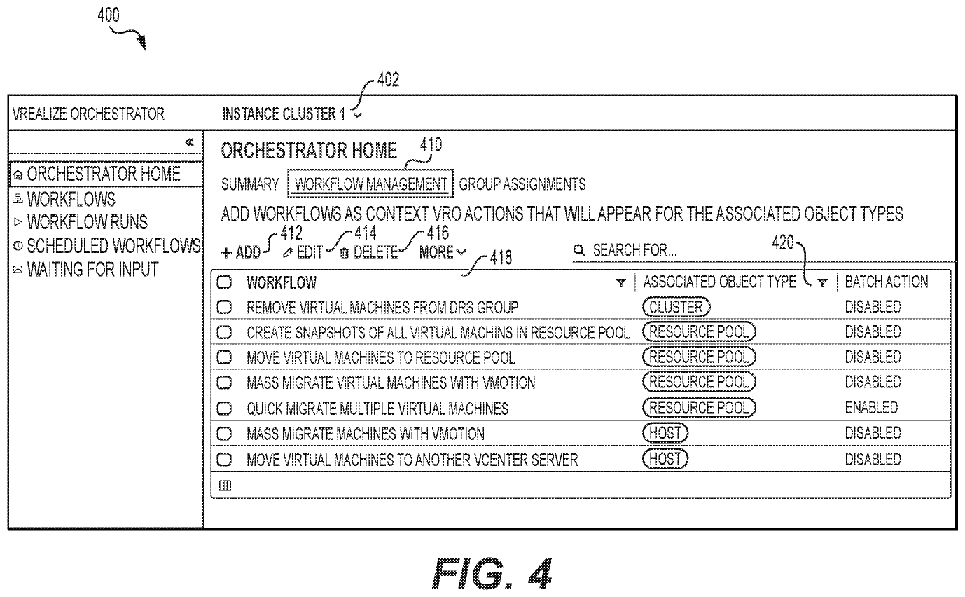

When an admin user creates a new automated workflow, settings for the automated workflow, such as a selected workflow and object type, can be sent to and retained by the workflow automation application. For example, the workflow automation plug-in can send the selected settings to the work automation application. The workflow automation plug-in can send the selected settings using any appropriate communication protocol, such as an Application Programming Interface (“API”) call or a Hypertext Transfer Protocol Secure (“HTTPS”) call. The automated workflow page at the server management application GUI can populate a list of workflows for a server cluster, and the list of workflows can be provided from the server management application through the plug-in. An example of the automated workflow page described above is illustrated in FIG. 4 and is described in more detail later herein.

At stage 120, the workflow automation application can create a contextual element for the defined automated workflow. For example, the plug-in can send information identifying the selected workflow and object type to the workflow automation application, the workflow automation application can create the contextual element with this information. In one example, a contextual element can be an array that includes mappings that point to data required to execute the workflow. An example of a contextual element is illustrated in TABLE 1 below.

TABLE 1

| VARIABLE | VALUE | TYPE |
|---|---|---|
| workflowName | Migrate virtual machine | string |
| workflowid | workflow1 | string |
| objectTypes | Array[1] | Array |
| objectTypename | Virtual Machine | string |

The example contextual element above includes three columns: “Variable,” “Value,” and “Type.” The Variable column indicates a variable that information on the corresponding row pertains to. The “Value” column includes the value(s) of the corresponding variable. The “type” column indicates the type of data provided in the Value column. In one example, the values in the Variable column can be the same for each contextual element. In the example above, the “workflowName” variable corresponds to the name of the workflow, which has a string value of “Migrate virtual machine.” The “workflowid” variable corresponds to an ID of the workflow, which has a string value of “workflow1.” The “objectTypes” variable corresponds to the type of object. For example, the objectType array value in the above example, “Array[1],” corresponds to an array with information identifying the corresponding objects of the object type. The objectTypename variable corresponds to the name of the object type, which has a string value of “Virtual Machine” in the example above.

The values in the contextual element can map to various entities at the server management application and the workflow automation application. For example, objectTypesname and the workflowName can map to fields in the automated workflow page of the plug-in GUI. As an example, the automated workflow page for a cluster can include a table that displays the available workflows that can be run on the cluster. The table can include a column with the workflow names and a column for the object types. The workflowName can map to the workflow names column, and the objectTypesname value can map to the object types column. When loading the automated workflow page for a cluster, the workflow plug-in can populate the table based on the mappings. This is described in more detail below at stages 170 and 180. The objectType array can map to data managed by the server management application, such as a data table, that identifies the individual entities of the corresponding object type in the cluster. As an example, Array[1] in the example contextual element can map to a data table with the IDs of VMs running on the corresponding server cluster. The workflowid value can map to script managed by the workflow automation application that, when executed, performs the corresponding workflow on the VMs identified in the data table.

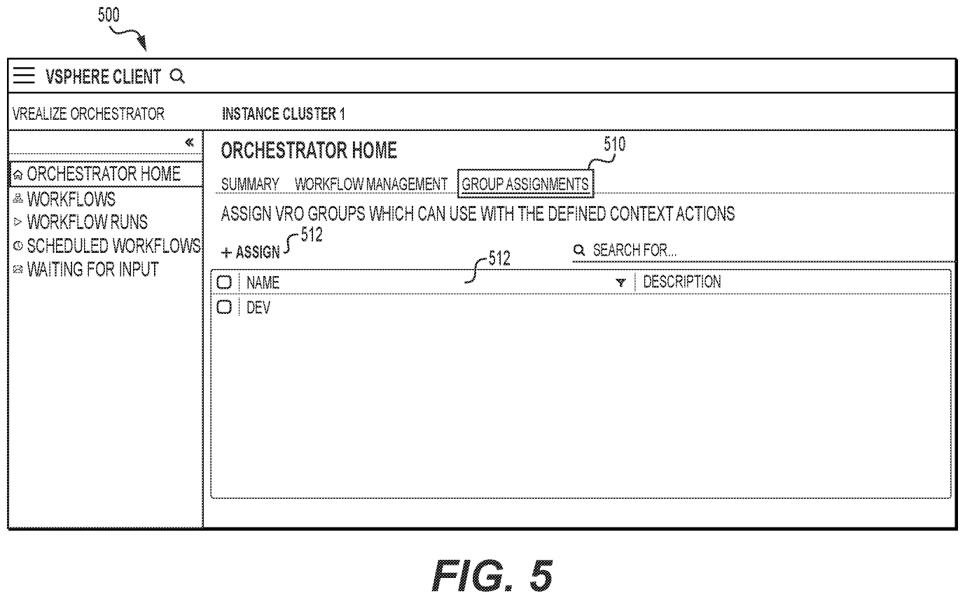

At stage 130, the workflow automation plug-in can receive an assignment of a user group to a server cluster. For example, the plug-in GUI can include a group assignment page. In one example, access to the group assignment page can be restricted to admin users. The group assignment page can allow an admin user to select which user groups can use the defined workflows on the cluster. A user group can be a defined group of users within an organization. Users can be assigned to one or multiple groups. Adding a group to a server cluster at the plug-in GUI can give users of the group access to the automated workflows created for the cluster. An example of the group assignment page described above is illustrated in FIG. 5 and is described in more detail later herein.

In one example, the plug-in GUI can allow the admin user to select the automated workflows that a user group can access. For example, when assigning a user group to a server cluster, the group assignment page can include an option for selecting all automated workflows or specifying the automated workflows that the user group can access. This option can populate the selectable list of automated workflows added to the cluster, and the admin user can select automated workflows to give the user group access to. The users in the user group can then be given access to only the selected automated workflows.

At stage 140, the workflow automation application can map the assigned user group to the contextual element. For example, each contextual element can have a unique ID, which can be generated by the workflow automation application when the contextual element is created. Also, each group can have a unique group ID. In one example, the contextual element ID can be a row in the contextual element array. As an example, the example contextual element from TABLE 1 can include a row with a Value of “contextualelementID,” a type of “string,” and a value for the contextual element ID, such as “contextualelement1.”

The workflow automation application can map the user group to the contextual element using the contextual element's unique ID. As an example, the workflow automation application can manage one or more data tables with information about various user groups, such as assigned users, a group name, a group ID, permissions, and so on. Such a table or array for a user group can include a field for contextual element IDs of automated workflows that the user group is assigned to. When an admin user assigns a user group to a cluster or a workflow in the plug-in GUI, in the backend the workflow automation application can add the corresponding contextual element ID to the user group's table. In one example, when an admin server assigns a group to a cluster, the workflow automation application can add the contextual element IDs for all automated workflows available for that cluster to the group's table. Alternatively, when an admin user adds an automated workflow to a cluster, the contextual element can map to a table associated with the cluster that includes the cluster's ID. The cluster table can include the contextual element IDs of all contextual elements added to the cluster. Group assignments can also be added to the cluster table. For example, the cluster table can include entries that include the group IDs of any assigned group. These mappings can later be used to load automated workflows for a user in the plug-in GUI, which is explained in more detail later herein regarding FIG. 1B.

The contextual elements utilize mappings to connect existing data stored in different applications and locations of a system to manage user authorization to execute workflows managed by a workflow automation application on server clusters managed by a server management application. For example, if an admin user creates a new automated workflow for a server cluster, the admin user does not need to then add permissions for users or a user group to access the new workflow. Upon creating the new automated workflow, the workflow automation application creates a new contextual element that maps to the cluster. Because user group assignments also map to clusters, adding an automated workflow to the cluster causes the new automated workflow to automatically appear in the plug-in GUI for users in the assigned user group.

FIG. 1B is a flowchart of an example method for implementing workflow automation authorizations. For example, the example method below can occur after stage 140 of FIG. 1A described above. At stage 150, the workflow automation plug-in can receive an access request associated with the server cluster. For example, an end user can navigate to the server cluster in the server management application and select a link corresponding to the plug-in. As an example, the server management application can be a web application that users can access through a web browser. The end user can enter a uniform resource locator (“URL”) for the server management application into the browser's address bar. A login page can be presented to the end user that the end user can then login to using security credentials. The end user can navigate to a cluster in the server management application, and the cluster's page can include a link for the launching the plug-in. Selecting the link can cause the plug-in to load the plug-in GUI with information specific to the cluster.

At stage 160, the workflow automation plug-in can determine that the end user profile is assigned to the user group. For example, when the end user selects the link for the plug-in, the plug-in can send information identifying the end user to the workflow automation application, including a user ID, for example. The workflow automation application can then identify any user groups that the end user belongs to. For example, information relating to user groups, including the user IDs of end users assigned to each group, can be stored at a specific location, such as a database server. The workflow automation application can query the database server for user groups that the end user's ID is assigned to, and the database server can respond with group IDs for any such user groups. Alternatively, the plug-in can obtain the group IDs and send them to the workflow automation application. For example, when the end user logs in to the server management application, the server management application can identify groups that the end user is assigned to. The plug-in can access this information and send the group IDs to the workflow automation application.

At stage 170, based on the end user profile being assigned to the user group, the workflow automation plug-in can retrieve contextual elements mapped to the cluster. For example, the plug-in can locate the group ID in a cluster data table that includes group IDs of groups assigned to the cluster. Assuming the group ID is in the cluster data table, the plug-in can identify the contextual elements mapped to the cluster based on contextual element IDs in the cluster's data table. The plug-in can then retrieve the corresponding contextual elements from another data table using their corresponding IDs. If the user does not belong to any groups assigned to the cluster, then the workflow automation plug-in can instead not retrieve any of the contextual elements for the cluster.

At stage 180, the workflow automation plug-in can display the available automated workflows in the plug-in GUI. For example, the plug-in can display the automated workflow page described previously herein, which can include a table with columns for at least the workflow name and object type associated with an automated workflow. Using the contextual element from TABLE 1 as an example, the plug-in can insert the workflowName Value of each contextual element into the workflow name column and insert the objectTypename Value into the object type column on the same row of its corresponding workflow name. If a user selects an automated workflow from the table, then the plug-in can use information in the underlying table to execute the workflow. For example, if the user selects the workflow corresponding to the contextual element of TABLE 1, then workflow1 can be executed on objects identified in Array[1]. In one example, the plug-in can send instructions to the cluster for executing the workflow. Alternatively, the plug-in can send the selection to the workflow automation application, and the workflow automation application can send the instructions.

The stages in the example method are described as being performed by the workflow automation plug-in. However, some or all of the stages can be performed by the workflow automation application. For example, at stage 160, the workflow automation plug-in can send the end user's ID and/or group IDs, and the workflow automation application can determine that the user is assigned to the group. At stage 170, the workflow automation application can retrieve an automated workflow corresponding to the contextual element assigned to the user group. At stage 180, the workflow automation application can send the automated workflow to the plug-in for displaying in the plug-in GUI.

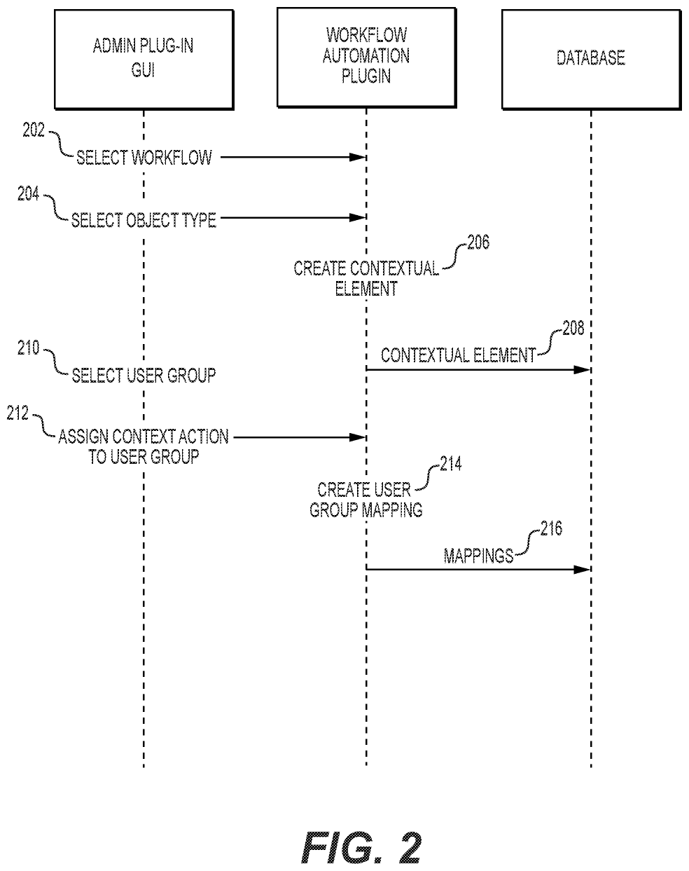

FIG. 2 is a sequence diagram of an example method for creating contextual elements for workflow authorization management. At stage 202, an admin user can select a workflow in an admin version of a workflow automation plug-in GUI (hereinafter referred to as the “admin plug-in GUI”). The plug-in GUI can be a portion of a server management GUI that corresponds to a plug-in for a workflow automation application. The admin user can be any user with permissions for creating and managing automated workflows. Admin users can have access to an admin version of the plug-in GUI where the admin users can create workflows and assign user groups to server clusters within the plug-in GUI.

To access the admin plug-in GUI, the admin user can first login to the server management application. As an example, the server management application can be a web application, and the admin user can login to the application by providing login credentials at a login page. The admin user can then be presented with a server management GUI for managing server clusters of a system. The admin user can navigate to a cluster, and the server management GUI can display a page for managing the cluster. The cluster page can include a link for the workflow automation plug-in, which, if selected, displays the admin plug-in GUI for managing workflows associated with the cluster.

The admin plug-in GUI can include a workflow management page that includes a list of all workflows previously added to the cluster and what type of objects the workflow acts on. An admin user can add, remove, and edit workflows. In one example, to add a workflow the admin user can select a selection mechanism, such as an “Add” button. This can cause the admin plug-in GUI to display a new workflow window for adding workflows. The new workflow window can include options for selecting a workflow and an object type. In an example, the workflows and object types displayed in the new workflow window can be populated from a database or data table previously created. For example, workflow scripts can be created and added to a storage location of the workflow automation application. Data relating to objects of a cluster and their object types can be retained at the server management application. The plug-in can retrieve a list of these workflow scripts and object type definitions and display them in the new workflow window. The admin user can then select a workflow and, at stage 204, can select an object type from the populated lists to define the new workflow.

At stage 206, the workflow automation plug-in can create a contextual element based on the selections. A contextual element can be a data table or array that includes data mapping to the workflow, data mapping to objects of the object type, and other necessary information for executing the workflow. For example, the contextual element can include a workflow name and object type name, which can both be used to populate a list of available workflows in the workflow management page. The contextual element can also include mappings that point to data for executing the workflow. Using the contextual element in TABLE 1 as an example, the value for the workflowid variable, workflow1, can map to a workflow script retained at another data table. The value for the objectTypes variable, Array[1], can map to another data table with objects of the corresponding object type. For example, objects in Array[1] can include the names or ID of VMs running in the cluster.

In an example, the plug-in can map the contextual element to the cluster. For example, the plug-in can create another data table that includes the cluster's ID and the IDs of contextual elements added to the cluster. When a user accesses the workflow automation page of the cluster, the plug-in can use this data table to retrieve the contextual elements of all workflows added to the server. For example, the plug-in can retrieve the contextual element of each contextual element ID and populate the list of workflows accordingly.

At stage 208, the workflow automation plug-in can store the contextual element at a database. The database can be any kind of storage component, such as a database server or a hard disk.

At stage 210, the admin user can assign a group to the cluster. For example, the admin plug-in GUI can include an assignment page that allows admin users to assign groups to the cluster. The admin user can select an option for adding a user group, which can cause the admin plug-in GUI to display a window for assigning a new user group. The admin user can select one or more user groups to assign to the cluster. In one example, a multi-selectable list of user groups can be displayed that allows the admin user to select one or multiple user groups. The admin user can also search for user groups using a search feature.

At stage 212, the admin user can assign the automated workflow to the user group. For example, after locating and selecting one or more user groups, the admin user can select a selection mechanism for assigning the selected groups.

At stage 214, the workflow automation plug-in can map the user group to the cluster. For example, the plug-in can create or modify a data table that associates cluster IDs and user group IDs for user groups assigned to the corresponding cluster. At stage 216, the workflow automation plug-in can store the user group mapping to the database. In one example, user group assignments can be stored in the same data table that associates clusters with contextual elements added to the cluster. For example, when a workflow is added or removed from a cluster, the plug-in can simply add or remove the corresponding contextual element ID from the data table. The plug-in can do the same for user group assignments by adding or removing user group IDs from the data table.

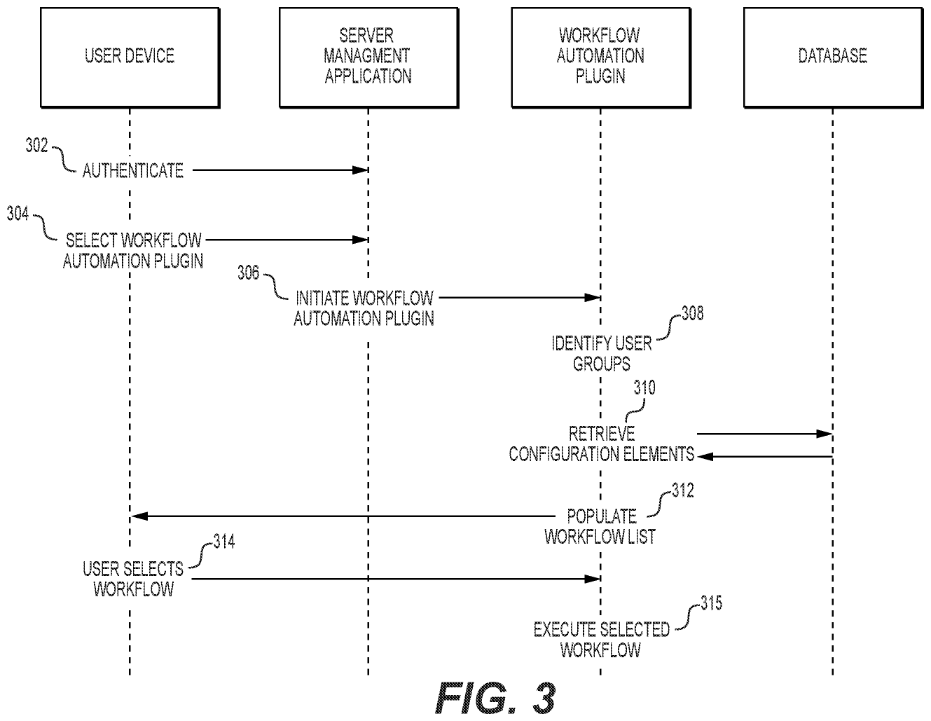

FIG. 3 is another sequence diagram of an example method for workflow authorization management. The example method below can occur after the method described in FIG. 2 above such that at least one contextual element and at least one user group is assigned to a cluster. At stage 302, an end user can authenticate with the server management application from a user device. The end user can authenticate by providing credentials at a login screen for the server management application, such as a username and password, or by providing credentials through an authentication application such as a single-sign-on application. The user device can send the credentials to the server management application where the credentials can be verified. The server management application can then provide access to a server management GUI for managing clusters in a computing system.

In one example, after logging in, the user can navigate to a page for a cluster in the system. This cluster page can include a link for the workflow automation plug-in, which the end user can select at stage 304. Selecting the plug-in link on the cluster's page can cause the server management application to initiate the plug-in for the cluster at stage 306. For example, the server management application can run a script or a set of code that causes the plug-in to begin executing.

At stage 308, the plug-in can identify a user group that the user is assigned to. This can include one or more user groups. In one example, the plug-in can identify user groups using the credentials used by the end user when logging in to the server management application. For example, the plug-in can access the end user's ID and query a directory database for user group IDs of user groups that the user is assigned to. Alternatively, the server management application can obtain the user group IDs and provide them to the plug-in after initiating the plug-in at stage 306.

At stage 310, the plug-in can retrieve configuration elements based on the user group assignments. The plug-in can do this using the data table mappings described previously herein. For example, contextual element IDs for workflows added to each cluster and user group IDs for user groups assigned to each cluster can be stored in a first data table. The contextual element IDs can map to contextual elements stored in a second data table. Data for executing workflows, such as scripts for executing workflows IDs of objects to executing the workflow on, can be stored in one or more other data tables. The plug-in can determine whether any of the group IDs of the end user's assigned groups is associated with the cluster in the first data table. If so, the plug-in can retrieve the contextual elements for the cluster from the second data table based on the contextual element IDs associated with the cluster in the first data table.

At stage 312, the plug-in can populate a list of workflows. As an example, the list can be a table with at least two columns: one for the name of the workflow and another for the object types that the workflow corresponds to. Using the contextual element in TABLE 1 as an example, one entry in the table can have “Migrate virtual machine” in the workflow name column and “Virtual Machine” in the object type column. This informs the end user that the workflow migrates VMs on the cluster.

At stage 314, the user can select a workflow. For example, the end user can click or tap on the workflow in the plug-in GUI to execute the workflow. The user device can send the selection to the plug-in.

At stage 315, the plug-in can execute the workflow using mappings the contextual element. For example, the contextual element can include at least two mappings: a first mapping can map to a script for executing the workflow and a second mapping can map to IDs of objects for executing the workflow on. Continuing the example above, the user can select the workflow corresponding to the contextual element in TABLE 1. The plug-in can then run the script corresponding to workflow1 on objects identified in Array[1]. As an example, the plug-in can retrieve the workflow1 script from a database or other storage component. The plug-in can also retrieve the data of Array[1], which includes the IDs of VMs running on the cluster. The plug-in can then execute the script using the VM IDs. The manner of doing so can depend on the script. In one example, for each VM the plug-in can insert the corresponding ID into the script, such as into a placeholder, and then execute the script on the servers hosting the VMs. In another example, the VM can execute the script on the VMs themselves.

FIG. 4 is an illustration of an example workflow management page 410 of a plug-in GUI 400 for workflow authorization management. The workflow management page 410 is an example of an admin view where admin users can modify automated workflows for a cluster. The cluster name 402 is displayed at the top of the plug-in GUI 400. The workflow management selection mechanisms that allow an admin user to respectively add, edit, or delete workflows for the cluster. The workflow management page 410 includes a workflow column 418 and an object type column 420. Values in the workflow column 418 include the name of a workflow, and values in the workflow column 418 include the names of object types for the workflow in the same row. In an end user view, an end user can select a row to execute the corresponding workflow on the cluster.

FIG. 5 is an illustration of an example group assignment page 510 for a plug-in GUI 500 for workflow authorization management. The group assignment page 510 includes an assign button 512 that an admin user can select to add a user group to the cluster. When an admin user selects the assign button 512, the plug-in GUI 500 can display a window where the admin can select one or more user groups for an organization and assign them to the cluster. The names of user groups added to the cluster can be displayed in a user group name column 512. End users in the corresponding user groups can have access to execute the automated workflows added to the cluster.

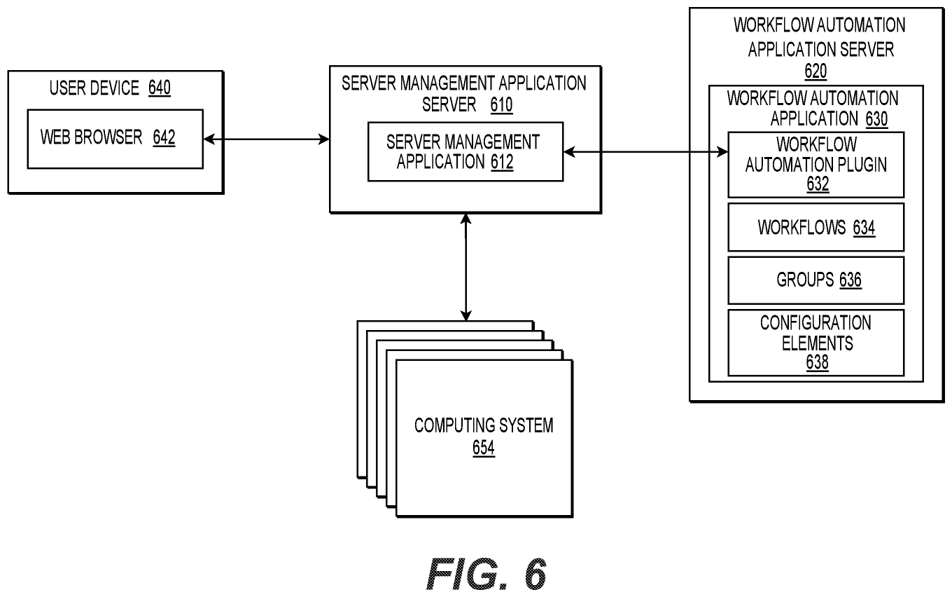

FIG. 6 is an illustration of an example system for performing workflow authorization management. A server management application server 610 can host a server management application 612. The server management application server 610 can be one or more servers or group of servers, including multiple servers implemented virtually across multiple computing platforms. The server management application 612 can be an application for managing servers and their associated components in a computing system 654. The computing system 654 can be a system of interconnected computing devices. The computing system 654 can include both physical and virtual devices, such as physical servers and VMs. In one example, the computing system 654 can be a cloud-based computing environment.

In one example, the server management application 612 can be a web application, and a user can access the server management application 612 through a web browser 642 running on a user device 640. Alternatively, the server management application 612 as a whole, an associated front-end GUI, or other components of the server management application 612 may be installed directly on the user device 640. Actions described herein as being performed by the server management GUI can be performed by the corresponding application or service rather than the server management GUI itself.

The user device 640 can be one or more processor-based devices, such as a personal computer, tablet, or cell phone. The web browser 642 can be an application that accesses content on the internet. A user can access the server management application 612 by navigating to the application's URL in the web browser 642, for example. The web browser 642 can also be a web-based application that displays information from a URL within a formatted application on the user device 640. The web browser 642 and the server management application server 610 can communicate using any appropriate communication protocol, such as API calls or HTTPS calls.

A workflow automation application server 620 can host a workflow automation application 630. The workflow automation application 630 can be a software application for managing automated workflows for servers and clusters managed by the server management application 612. The workflow automation application 630 can include a workflow automation plug-in 632 (hereinafter referred to as the “plug-in 632”). The plug-in 632 can be a software component that adds features of the workflow automation application 630 into the server management application 612. For example, the plug-in 632 can add features of the workflow automation application 630 into the server management application 612. The workflow automation application 630 can include various types of data for providing such features, such as the workflows 634, groups 636, and configuration elements 638. The workflows 634 can be scripts for executing workflows. The groups 636 can be a data table that associates assignments of groups to servers or clusters. Users belonging to a group assigned to a cluster can have permission to execute workflows on that cluster. The configuration elements 638 can define workflows and the types of objects that each workflow that is the target of the workflow. The configuration elements 638 can include data mapping them to their corresponding workflow 634 and to object type IDs for the corresponding object types.

In an example, the contextual elements 638 can map to their corresponding cluster in a data table, and the group IDs of assigned groups can map to the cluster in another data table. This allows admin users to quickly manage workflow permissions. For example, removing a contextual element from a cluster automatically removes the associated workflow for all associated users.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for workflow authorization management, comprising:
receiving, at a workflow automation application, a definition of an automated workflow for a server cluster, the definition including a workflow and an object type;
creating a contextual element based on the received definition, the contextual element being a first data table that includes a first mapping to a workflow script, a second mapping to an array of objects of the object type, and a third mapping to the server cluster in a second data table;
receiving, at the workflow automation application, an assignment of a user group to server cluster; and
creating a fourth mapping of the user group to the server cluster in the second data table.

2. The method of claim 1, wherein the workflow automation application is an application plug-in that runs in a server management application.

3. The method of claim 2, wherein the workflow script is stored at a location managed by the workflow automation application, and the array of objects of the object type is stored at a location managed by the server management application.

4. The method of claim 2, further comprising:
receiving, at a graphical user interface (“GUI”) of the server management application, a request to access a GUI page of the application plug-in corresponding to the server cluster, the request being associated with an end user profile;
determining, using the fourth mapping, that the end user profile is assigned to the user group;
based on the end user profile being assigned to the user group, retrieving the contextual element using the fourth mapping; and
displaying the automated workflow in the GUI page.

5. The method of claim 4, further comprising authenticating the end user profile using credentials previously provided to the server management application.

6. The method of claim 1, further comprising:
receiving a selection of the automated workflow; and
in response to the selection, executing the workflow on an object in the server cluster that corresponds to the object type defined in the automated workflow.

7. The method of claim 6, wherein executing the workflow comprises:
retrieving, using the first mapping, an executable code corresponding to the workflow script;
retrieving, using the second mapping, identifiers of objects of the object type; and
executing the executable code using the identifiers.

8. A non-transitory, computer-readable medium containing instructions that, when executed by a hardware-based processor, causes the processor to perform stages for workflow authorization management, the stages comprising:
receiving, at a workflow automation application, a definition of an automated workflow for a server cluster, the definition including a workflow and an object type;
creating a contextual element based on the received definition, the contextual element being a first data table that includes a first mapping to a workflow script, a second mapping to an array of objects of the object type, and a third mapping to the server cluster in a second data table;
receiving, at the workflow automation application, an assignment of a user group to server cluster; and
creating a fourth mapping of the user group to the server cluster in the second data table.

9. The non-transitory, computer-readable medium of claim 8, wherein the workflow automation application is an application plug-in that runs in a server management application.

10. The non-transitory, computer-readable medium of claim 9, wherein the workflow script is stored at a location managed by the workflow automation application, and the array of objects of the object type is stored at a location managed by the server management application.

11. The non-transitory, computer-readable medium of claim 9, the stages further comprising:
receiving, at a graphical user interface (“GUI”) of the server management application, a request to access a GUI page of the application plug-in corresponding to the server cluster, the request being associated with an end user profile;
determining, using the fourth mapping, that the end user profile is assigned to the user group;
based on the end user profile being assigned to the user group, retrieving the contextual element using the fourth mapping; and
displaying the automated workflow in the GUI page.

12. The non-transitory, computer-readable medium of claim 11, the stages further comprising authenticating the end user profile using credentials previously provided to the server management application.

13. The non-transitory, computer-readable medium of claim 8, the stages further comprising:
receiving a selection of the automated workflow; and
in response to the selection, executing the workflow on an object in the server cluster that corresponds to the object type defined in the automated workflow.

14. The non-transitory, computer-readable medium of claim 13, wherein executing the workflow comprises:
retrieving, using the first mapping, an executable code corresponding to the workflow script;
retrieving, using the second mapping, identifiers of objects of the object type; and
executing the executable code using the identifiers.

15. A system for workflow authorization management, comprising:
a memory storage including a non-transitory, computer-readable medium comprising instructions; and
a hardware-based processor that executes the instructions to carry out stages comprising:
receiving, at a workflow automation application, a definition of an automated workflow for a server cluster, the definition including a workflow and an object type;
creating a contextual element based on the received definition, the contextual element being a first data table that includes a first mapping to a workflow script, a second mapping to an array of objects of the object type, and a third mapping to the server cluster in a second data table;
receiving, at the workflow automation application, an assignment of a user group to server cluster; and
creating a fourth mapping of the user group to the server cluster in the second data table.

16. The system of claim 15, the workflow automation application is an application plug-in that runs in a server management application.

17. The system of claim 16, wherein the workflow script is stored at a location managed by the workflow automation application, and the array of objects of the object type is stored at a location managed by the server management application.

18. The system of claim 16, the stages further comprising:
receiving, at a graphical user interface (“GUI”) of the server management application, a request to access a GUI page of the application plug-in corresponding to the server cluster, the request being associated with an end user profile;
determining, using the fourth mapping, that the end user profile is assigned to the user group;
based on the end user profile being assigned to the user group, retrieving the contextual element using the fourth mapping; and
displaying the automated workflow in the GUI page.

19. The system of claim 18, the stages further comprising:
receiving a selection of the automated workflow; and
in response to the selection, executing the workflow on an object in the server cluster that corresponds to the object type defined in the automated workflow.

20. The system of claim 19, wherein executing the workflow comprises:
retrieving, using the first mapping, an executable code corresponding to the workflow script;
retrieving, using the second mapping, identifiers of objects of the object type; and
executing the executable code using the identifiers.
